(19) United States
(12) Patent Application Publication
(10) Pub. No.: US 2026/0183175 A1
(43) Pub. Date: Jul. 2, 2026

(54) SYSTEM AND METHODS FOR IMPROVING CONDITIONS OF THE VISUAL SYSTEM

(71) Applicant: Caterna Vision GmbH, Potsdam (DE)

(72) Inventors: Robert Lange, Potsdam (DE); Ron Lehnert, Berlin (DE); Uwe Kämpf, Potsdam (DE)

(21) Appl. No.: 19/130,738

(22) PCT Filed: Nov. 16, 2023
(86) PCT No.: PCT/EP2023/082086

§ 371 Date: May 16, 2025

(30) Foreign Application Priority Data
Nov. 16, 2022 (DE) 102022130362.4
Aug. 11, 2023 (DE) 102023121630.9

(51) Int. Cl. A61H 5/00; G06F 3/01

(52) U.S. Cl. CPC A61H 5/005; A61H 2201/5043; G06F 3/011

(57) ABSTRACT

A display system and methods for providing visual stimuli to a user to improve conditions related to amblyopia. The display system comprises a display device configured to provide left and right display elements and a computer unit for providing the visual content to the display device. The computer unit is configured to provide to the left display element left visual content comprising a left base layer and a left stimulation layer and to the right display element right visual content comprising a right base layer and a right stimulation layer. The left stimulation layer and/or the right stimulation layer is/are implemented with one or more mix functions to display a grating image on the display device. The mix functions are configured to exhibit spatial frequency and drift velocity so the grating image of the left stimulation layer and/or the right stimulation layer moves continuously across the display device.

### FIELD OF THE INVENTION

This application aspects priority of the German Patent Application number DE 10 2022 130 362.4, filed on 16 Nov. 2022 and German Patent Application number DE 10 2023 121 630.9, filed on 11 Aug. 2023. The entire disclosure of the German Patent Application number DE 10 2022 130 362.4 and DE 10 2023 121 630.9 is hereby incorporated herein by reference.

The field of the invention relates to a display system and methods for providing visual stimuli in order to improve conditions of the visual system, such as neurodevelopmental and neurodegenerative conditions, in particular conditions related to amblyopia and dry age-related macular degeneration (AMD).

### BACKGROUND OF THE INVENTION

The visual system comprises the sensory organ (eye) and parts of the central nervous system (the retina containing photoreceptor cells, the optic nerve, the optic tract, and the visual cortex). The visual cortex of the brain is the area of the cerebral cortex that processes visual information. Sensory input originating from the eyes travels through the lateral geniculate nucleus in the thalamus and then reaches the visual cortex. A disfunction of the vision system is usually caused by an inadequate development of the eyes and/or may be related to neuronal conditions in the brain. Such an impairment of the vision system is known, for example, but not limited to, for amblyopia, dry age-related macular degeneration (AMD), glaucoma, or progressive myopia. These impairments are referred to in the following description as “conditions of the visual system.”

Amblyopia is the term used to describe the visual impairment of one (or, more rarely, both) eyes due to an inadequate development of the visual system during early childhood. The result is a reduction in visual acuity that cannot be explained by organic defects in the eyes, or at least not sufficiently, and that persists even with optical correction, such as glasses or contact lenses.

The solutions for improving conditions of the visual system (such as amblyopia) proposed in the prior art usually rely on two approaches. A first approach comprises physically occluding one eye of a user (usually the stronger eye, i.e., the eye with the higher visual acuity). The weaker eye, i.e., the eye with the lower visual acuity, therefore, experiences a higher visual demand which improves the vision system over time.

A second approach comprises providing visual content to both of the eyes of the user in a complementary manner. This presentation is often also referred to as a dichoptic presentation of visual content. The dichoptic presentation usually displays occluded or blurred visual content so that the left eye sees a part of a scene clearly which is perceived occluded or blurred by the right eye and vice versa. A larger amount of clearly visible visual content is provided to the weaker eye of the user. The weaker eye therefore faces a higher visual demand which improves the vision system over time.

Several publications are known to describe apparatus and method for improving the visual cortex.

For example, the German Patent DE 10 2011 119 361 B4 describes an apparatus which physically enables the occlusion of one eye of a user. The user views, with the other eye, a moving grating image on one screen. The document does not disclose specific parameters (such as spatial frequency or drift velocity) or ranges of parameters with respect to the grating image which may be beneficial to the improvement of the visual condition.

The US Patent Application Publication US 2017/0296419 A1 describes a method of treating, improving, or preventing degradation of a user's vision utilizing a treatment system comprising a head-mounted apparatus. The apparatus has a first and a second display screen for, respectively, displaying visual content to a left and a right eye of the user in a dichoptic manner. The document does not disclose the use of grating images in the visual content.

The International Patent Application WO 2016/029295 A1 describes a system and a method for providing complementary dichoptic stimulation to a user's left eye and right eye. The provided visual content is occluded by patterned masks so that neither the user's left eye nor right eye receive a complete representation of a source image. The document, however, does not disclose the use of such patterned masks for non-dichoptic visual content.

Kelly (J. Opt. Soc. Am., Vol. 69, No. 10, October 1979) describes the use of drifting gratings as visual stimuli for determination of contrast sensitivity of the visual system. The drifting gratings exhibit a spatial frequency (measured in cycles per degree, cyc/deg) and a temporal frequency (measured in cycles per second, cyc/sec). A reciprocal relationship between the spatial frequency and the temporal frequency concerning the visual resolution for uniformly drifting gratings is demonstrated in the paper. The reciprocal relationship was articulated in the context of sinusoidal grating drift velocity calibration and is expressed by an equation: drift velocity=temporal frequency/spatial frequency (measured in degrees per second). This equation from Kelly and applied to data in Kelly enables calculation of the required drift velocity for the sinusoidal gratings dependent on the values of the temporal frequencies and the spatial frequencies used for the visual stimuli.

The solutions proposed in the prior art rely on either the physical occlusion of one eye or on presenting visual content in a dichoptic manner. The prior art, however, does not disclose a system or method for improving conditions of the visual system using one or two display elements and providing user-dependent grating images to a user in a stimulative manner.

### SUMMARY OF THE INVENTION

The present document describes a display system and methods for providing visual stimuli to a user in order to improve conditions of the visual system. Conditions related to amblyopia, dry age-related macular degeneration (AMD), glaucoma, or progressive myopia can be addressed by the present invention. The system and method are not, however, limited to these conditions and can be used to improve other conditions of the visual system.

In accordance with one aspect of the present disclosure, a display system for displaying visual content is provided for a user. The display system comprises a display device. The display device is configured to provide a left display element and a right display element. The display system further comprises a computer unit for providing the visual content to the display device. The computer unit is configured to provide to the left display element left visual content comprising a left base layer and a left stimulation layer and to the right display element right visual content comprising a right base layer and a right stimulation layer. The left stimulation layer and/or the right stimulation layer is/are implemented with one or more mix functions. The left base layer, the left stimulation layer, and the one or more mix functions as well as the right base layer, the right stimulation layer, and the one or more mix functions generates a grating image so that the grating image is displayed on the left display element and/or the right display element of the display device. The base layer comprises visual content such as, but not limited to, solid black, white, grey, or color images, gradient images captured images, or image streams. The stimulation layer comprises visual content such as, but not limited to, solid black, white, grey, or color images, gradient images, captured images, image streams, or a modified image of the base layer, for example, a blurred image of the image used in the base layer. The mix functions are configured to exhibit a spatial frequency and a drift velocity so that the grating image of the left stimulation layer and/or the right stimulation layer moves continuously across the display device.

The display system according to one aspect enables the display of visual content so that conditions of the visual system of the user can be improved. The grating images displayed on the left display element and/or the right display element provide visual stimuli to the user's eyes and show a physiological effect on the vision system of the user.

In accordance with one aspect of the present disclosure, the display system can be further configured to enable modifications of the grating images, such as, but not limited to, setting the spatial frequency in the range of 0 to 60 cycles per degree, setting the drift velocity in the range of 0 to 32 degrees per second, setting a temporal frequency in the range of 0 to 32 cycles per second, selecting a sinusoidal waveform, or setting a phase shift in the range of 0 to 179 degree between two adjacent ones of the grating images, or changing the spatial frequency and/or the drift velocity of a grating image after a period of time. The mix functions can also be modified to generate a circular grating type. The circular grating type exhibits a plurality of moving concentric circles.

The display system according to one aspect enables user-adaptive modifications of the grating images. These modifications allow the user to adapt the visual stimuli to individual conditions of the visual system. Modified grating images contribute to the improvement of the conditions of the visual system.

In accordance with one aspect of the present disclosure, the display system can be configured to reduce the drift velocity of the grating image to 0 degrees per second after a period of time. The grating image generated by the mix functions does not move across the display element in this third aspect so that the grating image is displayed statically. Subsequently, the left visual content is provided to the right display element and the right visual content is provided to the left display element, i.e., the visual contents of both display elements are swapped.

The display system according to one aspect enables the generation of a further physiological effect, referred to as interocular transfer, which may be beneficial to the improvement of the conditions of the visual system.

In accordance with one aspect of the present disclosure, the display system can be configured to provide a grating image on the left display element and on the right display element. The mix functions which are executed using the left stimulation layer and the mix functions which are executed using the right stimulation layer can differ in the drift velocities and the spatial frequencies.

The display system according to one aspect enables the generation of a further physiological effect, referred to as interocular beat, which may be beneficial to the improvement of the conditions of the visual system.

The display system is further configured to provide visual content in a foreground. The left visual content and the right visual content hence comprise a left foreground and a right foreground. The left foreground and the right foreground can be alike. The visual content provided in the foreground serves the purpose that the user pays more attention and therefore spends more time focusing on the display device which benefits the improvement of the conditions of the visual system.

The display system further comprises a feedback device and an input device. The feedback device allows the user to provide feedback to the computer unit. The feedback device can be a push button to indicate a particular situation like a perceived change of the visual content, or a game controller to interact with the provided visual content. The input device allows the user to modify the grating image according to user configurable settings.

The present disclosure also describes a method for providing visual stimuli to a user. The method comprises, in a first step, displaying visual content so that the visual content is displayed on a left display element and on a right display element of a display device. The left display element is viewable with a left eye of the user and the right display element is viewable with a right eye of the user. In a next step, a left visual content comprising a left base layer and a left stimulation layer is provided to the left display element and a right visual content comprising a right base layer and a right stimulation layer is provided to the right display element using a computing unit. Subsequently, one or more mix functions are executed using the left stimulation layer or the right stimulation layer. A grating image is then displayed on the display device. The mix functions are configured to exhibit a spatial frequency and a drift velocity so that the grating image of the left stimulation layer or the grating image of the right stimulation layer moves continuously across the display device.

The method enables the display of grating images to one eye of the user. The method therefore provides visual stimuli in a monocular manner.

The method may comprise in a further step selecting values with respect to the spatial frequencies, the drift velocities, a waveform, a phase shift, a grating type, a grating orientation of the one or more mix functions using an input device. This step allows the user to display the grating image according to user configurable settings.

The present document also describes another method for providing visual stimuli to a user. The method comprises, in a first step, displaying visual content to a left eye and a right eye of the user, in a next step providing the visual content comprising a left base layer and a left stimulation layer as well as a right base layer and a right stimulation layer using a computer unit, and, in a further step, executing one or more mix functions using the left stimulation layer or the right stimulation layer, as described above. Subsequently, the drift velocity of the grating image is reduced to 0 degrees per second after a period of time. The grating image is then displayed in a static manner. In a last step, the left visual content and the right visual content are swapped so that the left visual content is provided to the right display element and the right visual content is provided to the left display element.

The described method enables the display of grating images to one eye of the user. The method therefore provides visual stimuli in a monocular manner.

The method may comprise in a further step receiving feedback from the user using a feedback device. The feedback provided by the user may be used to measure, describe, or analyze the conditions of the visual system of the user.

The method may also comprise in a further step selecting values to adapt the grating image according to user configurable settings using an input device. The settings may be selected based on the analysis of the provided user feedback.

The present document also describes a third method for providing visual stimuli to a user. The method comprises, as discussed above, in a first step displaying visual content to a left eye of the user and a right eye of the user and in a next step providing the visual content comprising a left base layer and a left stimulation layer as well as a right base layer and a right stimulation layer using a computer unit. Subsequently, one or more mix functions are executed using both of the left stimulation layer and the right stimulation layer so that the grating image of the left stimulation layer and the grating image of the right stimulation layer move continuously across the display device.

The described method enables the display of grating images to both eyes of the user. The method therefore provides visual stimuli in a binocular manner.

The method may also comprise in a further step selecting values to adapt the grating images according to user configurable settings using an input device.

In accordance with one aspect of the present disclosure, the display system comprises a display device for displaying the visual content on a display element. A computer unit provides the visual content to the display device. The computer unit is configured to provide to the display element the visual content comprising a base layer and a stimulation layer. The stimulation layer is implemented with one or more mix functions to display a grating image on the display device. The one or more mix functions are configured to exhibit a spatial frequency and a drift velocity so that the grating image of the stimulation layer moves continuously across the display device.

The display system according to one aspect enables the generation of a visual stimuli which may be beneficial to the improvement of the conditions of the visual system.

The grating image according to one aspect can be adapted by setting various parameters of the one or more mix functions. The various parameters of the one or more mix functions may comprise, for example, but not limited to, the spatial frequency in the range of 0 to 60 cycles per degree, the drift velocity in the range of 0 to 32 degrees per second, and a waveform in the form of a sinusoidal wave. The spatial frequency may also comprise a first spatial frequency for a first period of time and a second spatial frequency for a second period of time. The drift velocity may further comprise a first drift velocity for a first period of time and a second drift velocity for a second period of time. The one or more mix functions may further be configured to generate a circular grating type in the form of concentric circles.

The change of grating images enables user-adaptive modifications. These modifications allow the user to adapt the visual stimuli to individual conditions of the visual system. Modified grating images contribute to the improvement of the conditions of the visual system.

The computer unit is also configured to provide to the display element visual content in a foreground. The foreground can comprise at least one of video games or interactive content. A feedback device is provided so that the user can provide feedback to the computer unit.

The visual content provided in the foreground serves the purpose that the user pays more attention and therefore spends more time focusing on the display device which benefits the improvement of the conditions of the visual system. The visual content in the foreground may hence also be referred to as “attention binding”.

The display system may also comprise an input device. The input device is provided so that at least one of the spatial frequencies, the drift velocities, the waveform, the grating type, and a grating orientation of the one or more mix functions is set according to a user configurable setting. The input device allows the user to modify the grating image according to user configurable settings.

The present document also describes a fourth method for providing visual stimuli to a user. The method comprises displaying visual content so that the visual content is displayed on a display element of a display device. The display element is viewable with at least one of a left eye and a right eye of the user. In the next step, the visual content is provided to the display element using a computing unit. The visual content comprises a base layer and a stimulation layer. One or more mix functions are executed using the stimulation layer for displaying a grating image on the display device. The one or more mix functions are configured to exhibit a spatial frequency and a drift velocity so that the grating image of the stimulation layer moves continuously across the display device.

The fourth method can provide visual stimuli in a binocular manner on one display element which may be beneficial to the improvement of the conditions of the visual system.

The method may comprise in a further step selecting values with respect to the spatial frequency, the drift velocity, a waveform, a grating type, and a grating orientation of the one or more mix functions for displaying a user configurable grating image using an input device. This step allows the user to display the grating image according to user configurable settings.

### DESCRIPTION OF THE FIGURES

FIG. 1A shows a schematic illustration of one aspect of a display system for displaying visual content to a user.

FIG. 1B shows a schematic illustration of a display device comprising a left display element and a right display element.

FIG. 1C shows a view of a display device displaying a left visual content and a right visual content.

FIG. 2A shows a schematic illustration of one aspect of a display system for providing visual content comprising a base layer, a stimulation layer, and a foreground.

FIG. 2B shows a schematic illustration of a mix function with a diagram of the mix function.

FIG. 3A shows a view of a display device displaying a left visual content and a right visual content according to one aspect of the display system.

FIG. 3B shows a view of a display device displaying a left visual content and a right visual content according to one aspect of the display system.

FIG. 4A shows a view of a display device displaying a left visual content and a right visual content according to one aspect of the display system.

FIG. 4B shows a view of a display device displaying a left visual content and a right visual content according to one aspect of the display system.

FIG. 5 shows a flow chart describing a method for displaying visual content according to one aspect.

FIG. 6 shows a flow chart describing a method for displaying visual content according to one aspect.

FIG. 7 shows a flow chart describing a method for displaying visual content according to one aspect.

FIG. 8A shows a schematic illustration of one aspect of a display system for providing visual content comprising a base layer and a stimulation layer.

FIG. 8B shows a schematic illustration of one aspect of a display system for providing visual content comprising a base layer, a stimulation layer, and a foreground.

FIG. 9 shows a flow chart describing a method for displaying visual content according to one aspect.

FIG. 10 shows a diagram illustrating an increase of the visual acuity of users using grating images to improve their vision system.

FIG. 11A shows a diagram illustrating an increase of the visual acuity of users using grating images to improve their vision system.

FIG. 11B shows a diagram illustrating an increase of the visual acuity of users using grating images to improve their vision system.

FIG. 12 shows a table comprising various parameters for setting grating images provided to users.

FIG. 13 shows a table comprising various parameters for setting grating images provided to users.

FIG. 14A shows a sinusoidal wave and a rectangular wave.

FIG. 14B shows the formation of a rectangular waveform by multiple sinusoidal waves.

FIG. 15A shows a flowchart of a parameter selection method.

FIG. 15B illustrates a user-dependent selection of a spatial frequency and a temporal frequency.

FIG. 15C illustrates in a diagram the relationship between spatial frequencies and contrast sensitivity.

FIG. 16 shows a table comprising data of various lines of an eye chart corresponding to different spatial frequencies.

### DETAILED DESCRIPTION OF THE INVENTION

The invention will now be described on the basis of the figures. It will be understood that the embodiments and aspects of the invention described herein are only examples and do not limit the protective scope of the aspects in any way. The invention is defined by the aspects and their equivalents. It will be understood that features of one aspect or embodiment of the invention can be combined with a feature of a different aspect or aspects and/or embodiments of the invention.

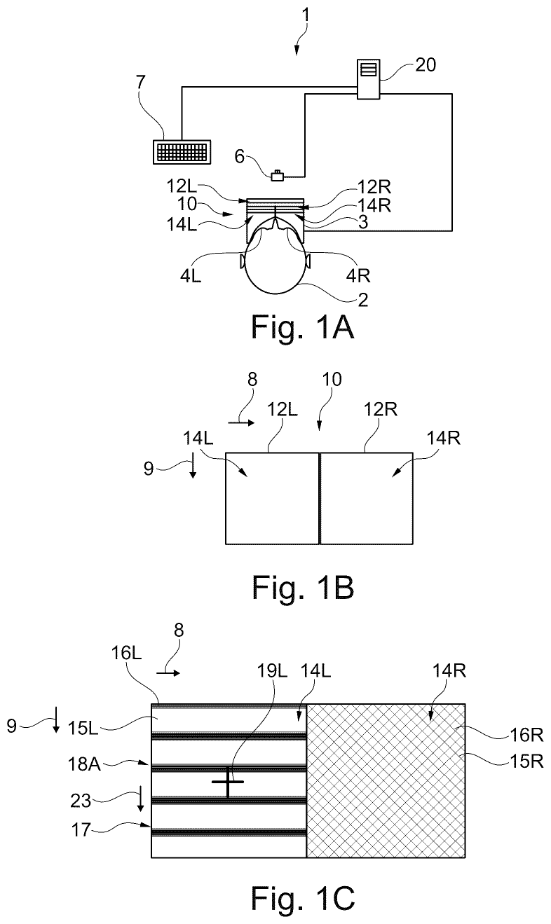

FIG. 1A shows a schematic illustration of a one aspect of a display system 1 for displaying visual content to a user 2. The display system 1 comprises a display device 10, a computer unit 20, an input device 7, and a feedback device 6.

The user 2 is undergoing a method for improving conditions of the visual system of their left and/or right eye (4L, 4R). The conditions of the visual system relate, for example, to amblyopia. The user 2 may also be an optician or an ophthalmologist assisting the user by setting the correct parameters such as, but not limited to, spatial frequency, drift velocity, waveform, grating type, grating orientation, phase shift, of the one or more mix functions 17 using the input device 7.

According to one aspect of the display system 1, the display device 10 is, for example, a smartphone which is arranged in a head-mounted apparatus 3. The smartphone is configured to provide the left display element 12L and the right display element 12R on a single display. The computer unit 20, for example a laptop, provides the left visual content 14L and the right visual content 14R to both of the display elements 12L and 12R of the smartphone.

The display device 10 may also comprise other devices such as, but not limited to, commercially available Augmented Reality (AR)/Virtual Reality (VR) display devices or an apparatus configured to accommodate two separate screen devices.

The computer unit 20 can be integrated into the display device 20, as for example in smartphones or tablets. The computer unit 20 may also be, for instance, a stationary desktop or a server. It is understood that the display device 10 and the computer unit 20 are equipped with additional communication software and devices (e.g., antennas or connectors) so that the processed visual content can be provided to and displayed on the display device 10 via wireless or wired communication.

The feedback device 6 is configured to enable feedback from the user 2 to the computer unit 20. The feedback device 6 can be, for example, a push button that is pushed by the user 2 for indicating that a predetermined event occurred or that a certain condition was met, for instance a change in color of the visual content occurred. The feedback provided by the user 2 is then received, processed, and stored by the computer unit 2. The feedback device 6 may also comprise, for example, a game controller which allows the user 2 to interact with the displayed visual content. In general, the feedback device 6 may comprise all types of devices that allow the user 2 to provide the necessary feedback to the computer unit 2. It will be noted that the feedback device 6 may be omitted in other aspects of the invention.

The input device 7 is configured to enable user input from the user to the computer unit 20. The user input can comprise, for example, parameters regarding the display of the left visual content 14L and the right visual content 14R. One parameter may be, for example, a color of the base layer. Another input parameter may be a user's choice regarding the visual content which is to be displayed, for example the selection of a game. In general, the input device 7 may comprise all types of devices that allow the user 2 to provide the necessary input to the computer unit 2. It will be noted that the input device 7 may be omitted in other aspects of the invention.

FIG. 1B shows a schematic illustration of the display device 10 comprising the left display element 12L and the right display element 12R which are arranged adjacently to each other. The computer unit 20 (not depicted in FIG. 1B) provides a left visual content 14L to the left display element 12L and a right visual content 14R to the right display element 12R. The display device 10 is arranged so that the user 2 can view the left display element 12L with the left eye 4L and the right display element 12R with the right eye 4R.

It is understood that the left display element 12L and the right display element 12R have an image resolution which is described by a number of pixels in a horizontal direction 8 and a vertical direction 9. The total number of pixels and their values form an image that when displayed on the left display element 12L or the right display element 12R is viewable by the user 2.

FIG. 1C shows a view of the display device 10 (according to FIG. 1B) displaying the visual content. The left visual content 14L shows a grating image 18A generated, for example, by a left base layer 16L with solid black, a left stimulation layer 15L with solid white, and a mix function 17 implemented as a sinusoidal waveform oriented in a vertical direction 9. The mix function 17 mixes the left stimulation layer 15L with the left base layer 16L. The left visual content 14L further shows a grey fixation cross in a foreground 19L. The grating image 18A is further configured to move continuously across the left display device 12L along the vertical direction 9 indicated by a speed vector 23 pointing in the vertical direction 9. The right visual content 14R shows a right base layer 16R with solid black and a right stimulation layer 15R with solid black.

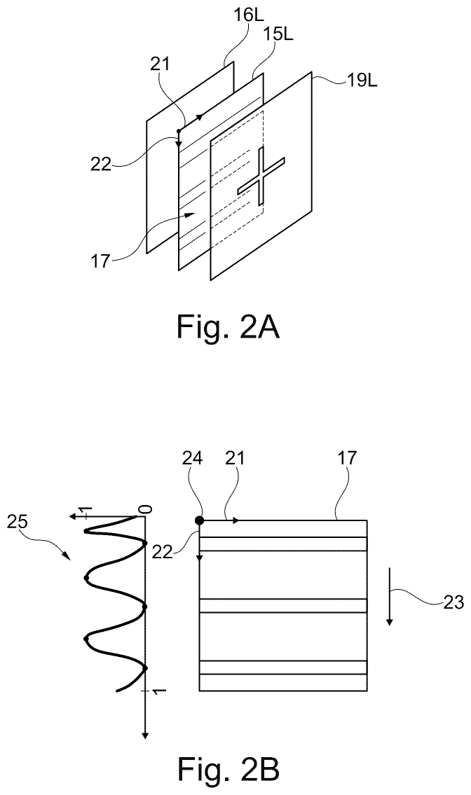

FIG. 2A shows a schematic illustration of one aspect of the display system 1 for providing the visual content. The second aspect illustrates a specific composition of the left visual content 14L and the right visual content 14R created by the computer unit 20. In FIG. 2A, the composition is illustrated in the form of layers by using the left visual content 14L of FIG. 1C. The layers can be equally sized and correspond to the size and resolution of the left display element 12L. The layers may also have a different size and resolution as the left display element 12L. The composition comprises a first layer (the left base layer 16L), a second layer (the left stimulation layer 15L), and a third layer (the left foreground 19L). The left base layer 16L exhibits a solid black. The left base layer 16L is overlaid with the left stimulation layer 15L exhibiting a solid white and the mix function 17. The left stimulation layer 15L exhibits the same orientation as the left base layer 16L. The left stimulation layer 15L further exhibits a first direction of implementation 21 (in the horizontal direction 8) and a second direction of implementation 22 (in the vertical direction 9). The first direction of implementation 21 and the second direction of implementation 22 indicate directions in which the mix functions 17 can be implemented. In FIG. 2A, the mix function 17 is implemented along the second direction of implementation 22 of the left stimulation layer 15L and exhibits a specific waveform. The left base layer 16L, the left stimulation layer 15L, and the mix function 17 generate the grating image 18A which exhibits transitions from black to white and vice versa in a gradual manner, as seen in FIG. 1C. The left foreground 19L comprises only the grey fixation cross.

The composition illustrated in FIG. 2A, as discussed above, displays the left visual content 14L in such a way that the user 2 perceives the grating image 18A to be behind the visual content of the left foreground 19L. In other words, the visual content of the left foreground 19L is not occluded by the left base layer 16L, the left stimulation layer 15L, and the one or more implemented mix functions 17. It will also be noted that the computer unit 20 can create the composition of the left visual content 14L and the right visual content 14R separately from each other. For instance, the computer unit 20 can create different visual contents by using different images for the left base layer 16L and the right base layer 16R or by executing different mix functions 17. The different mix functions 17 may differ in number and type. There can be different visual content in the left foreground 19L and the right foreground 19R.

The left base layer 16L and the right base layer 16R constitute images. The images can be solid black, as discussed with respect to FIG. 1C. Other examples of the images are, but not limited to, solid white, grey, or color images, gradient images or images captured by a camera, for instance by a camera of a smartphone. The images may also change over time, for example in the case of an image stream, e.g., image stream of the surroundings captured by the front camera or the rear camera of the smartphone, or a video/movie.

The left stimulation layer 15L and the right stimulation layer 15R constitute images on which the one or more mix functions 17 are executed. The images used for the left stimulation layer 15L and the right stimulation layer 15R can exhibit the same variety as discussed for the left base layer 16L and the right base layer 16R. The left stimulation layer 15L and the right stimulation layer 15R can also have the identical images as the left base layer 16L and the right base layer 16R or modified images of the left base layer 16L and the right base layer 16R (modifying images of the left base layer 16L and the right base layer 16R can comprise modifications such as, but not limited to, with respect to intensity, color, blurring, etc.). In another aspect of the display system 1, the image content of one of the left stimulation layer 15L or the right stimulation layer 15R may be at least partially empty, i.e., transparent. In a further aspect of the invention, the composition may also comprise more than one stimulation layer.

The left foreground 19L and the right foreground 19R are immediately visible to the user 2, as discussed above. It will be noted that the visual content of the left foreground 19L and the right foreground 19R may be provided to just one of the left display element 12L or the right display element 12R, as seen in FIG. 1C. The visual content in the foreground can also be provided to both of the left display element 12L and the right display element 12R with either different visual contents in the left display element 12L and the right display element 12R, or with visual content which is alike in both of the left display element 12L and the right display element 12R. In another aspect of the display system 1, the visual content in the left foreground 19L and the right foreground 19R may be omitted. The visual content in the left foreground 19L and/or the right foreground 19R serves the purpose that the user 2 pays more attention and therefore spends more time focusing on the left display element 12L and the right display element 12R of the display device 10. The visual content in the foreground may therefore comprise any kind of visual content that lengthens the period of the user's attention, such as, but not limited to, static images, like the grey fixation cross in FIG. 1C, or video games.

FIG. 2B shows a schematic illustration of the implemented mix function 17 of FIG. 2A. The illustration in FIG. 2B further comprises a diagram 25 representing an exemplary mix function 17. An origin of a coordinate system 24 is defined in the upper left corner. The origin defines the starting point of two directions: the first direction of implementation 21 and the second direction of implementation 22. The angle between the first direction of implementation 21 and the second direction of implementation 22 is 90 degrees, i.e., the first direction of implementation 21 and the second direction of implementation 22 are orthogonal.

The exemplary mix function 17 in FIG. 2B illustrated by diagram 25 is implemented along the second direction of implementation 22. The mix function 17 mixes a pixel value from the stimulation layer with the value of the corresponding pixel in the base layer with respect to a predetermined ratio. The predetermined ratio is determined by the mix function 17 which exhibits a sinusoidal waveform between a maximum value of 1 and a minimum value of 0. The value 1 corresponds to the case in which only the pixel value of the stimulation layer is displayed. The value 0 corresponds to the case in which only the pixel value of the base layer is displayed. The distance along the second direction of implementation 22 between the maximum value and the minimum value determines the spatial frequency (determined, for example, in cycles per degree). For a given spatial frequency of the mix function 17, a modified pixel value can be assigned to every field. The modified values in the horizontal direction remain constant. In another aspect, a different waveform of the mix function 17 may be chosen, for example, but not limited to, a triangle function or a rectangle function.

The mix function 17 further exhibits an angular speed (determined, for example, in degrees per second), also referred to as drift velocity and indicated in FIG. 2B by a speed vector 23. The drift velocity, as shown in FIG. 2B, is an angular drift velocity projected on the retina of the user. The speed vector 23 indicates the direction of movement of the mix function 17 (for illustration purposes). The mix function 17 is implemented to cover the entire height of the left display element 12L along the vertical direction 9 which is indicated by “0” and “1” in the diagram 25 of FIG. 2B. The waveform of the mix function 17 is continued when the mix function 17 moves with a given drift velocity in the direction of the speed vector 23. The mix function 17 is therefore considered to be continuous, i.e., not limited to a short distance on the left display element 12L. The speed vector 23 points in the direction of the second direction of implementation 22 so that the resulting grating image (e.g., grating image 18A) continuously moves with the given drift velocity in the vertical direction 9.

The mix function 17 is executed using an underlying image in the stimulation layer, for example of the left stimulation layer 15L, as discussed with respect to FIG. 2A. Since the mix function 17 is not static, the left display element 12L displays dynamic visual content, i.e., the visual content changes over time. The value of each pixel of the left display element 12L therefore needs to be recalculated within a predetermined time step by the computer unit 20. For a given predetermined time step, every pixel value is recalculated based on the mix function 17 of the stimulation layer and the base layer. The modified image is displayed on the display device 10 and visible to the user 2. The user 2 will subsequently perceive the grating image 18A, as for example shown in FIG. 1C, which moves in the vertical direction 9. Other image processing techniques may also be used to implement the grating image 18A. It is understood that the image processing of the left base layer 16L, the right base layer 16R, the left stimulation layer 15L, and the right stimulation layer 15R using one or more mix functions 17 is executed substantially instantaneously by the computer unit 20. The image processing does therefore not affect the display of the left visual content 14L and/or the right visual content 14R.

The first direction of implementation 21 and the second direction of implementation 22, as seen in FIGS. 2A and 2B, coincide with the horizontal direction 8 and the vertical direction 9 of the left display element 12L. Other angles between, for example, the vertical direction 9 of the left display element 12L and the second direction of implementation 22 may be implemented so that the generated grating image 18A moves, for example, diagonally or horizontally across the left display element 12L. The grating image can also exhibit transitions from blurred to unblurred regions and vice versa in a gradual manner by using a blurred image of the base layer in the stimulation layer and the mix function 17. The mix functions 17 may also be configured so that the image of the stimulation layer is displayed on the display device 10 without modifications.

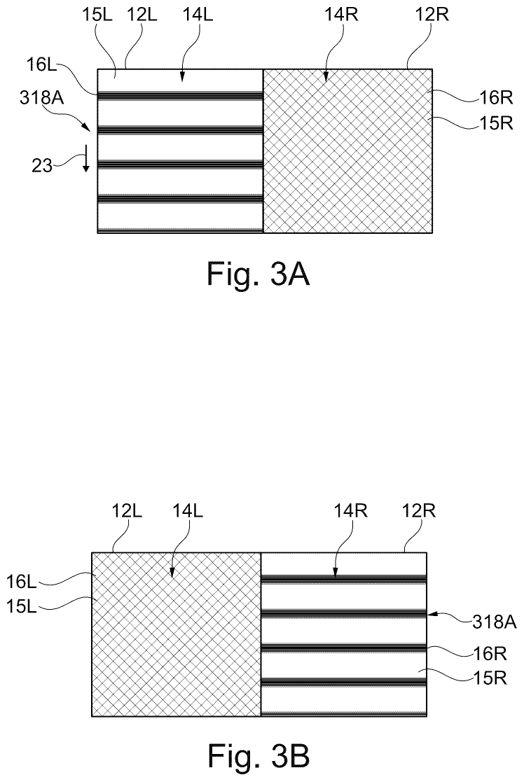

FIG. 3A shows a view of the display device 10 according to one aspect of the display system 1. The left visual content 14L shows a grating image 318A. The grating image 318A is generated by the left base layer 16L displaying a solid black, the left stimulation layer 15L displaying a solid white, and the mix function 17, as discussed with respect to FIG. 2B. The grating image 318A moves continuously across the left display element 12L in a vertical direction indicated by the speed vector 23. The right display element 12R shows the right base layer 16R and the right stimulation layer 15R displaying a solid black color without the grating image 318A. The visual content in the left foreground 19L and the right foreground 19R is omitted.

According to one aspect, the user 2 views the moving grating image 318A on the left display element 12L with the left eye 4L and the right base layer 16R and the right stimulation layer 15R with solid black on the right display element 12R with the right eye 4R for a predetermined period of time. If the predetermined period of time has reached its end time, the display system 1 is configured to reduce the drift velocity of the moving grating image 318A to 0 degrees per second. The display system 1 is further configured so that the remaining (static) grating image 318A of the left display element 12L is subsequently displayed on the right display element 12R, as seen in FIG. 3B. The right base layer 16R and the right stimulation layer 15R is then displayed on the left display element 12L, as seen in FIG. 3B. This procedure is referred to as a swap between the left visual content 14L and the right visual content 14R.

The display system 1 according to one aspect enables the generation of a visual effect perceived by the user 2. The user 2 will see a moving grating image 318A for a certain period of time shortly after the swap of the visual content although the displayed grating image 318A is static. This effect is also referred to as interocular transfer. The user 2 can provide feedback to the computer device 20 using the feedback device 6, for example, indicating the moment at which the user 2 perceives the grating image 318A as a static image. It will be noted that the display system 1 according to one aspect is also configured to perform the interocular transfer when the user 2 views the initial moving grating image 318A on the right display element 12R.

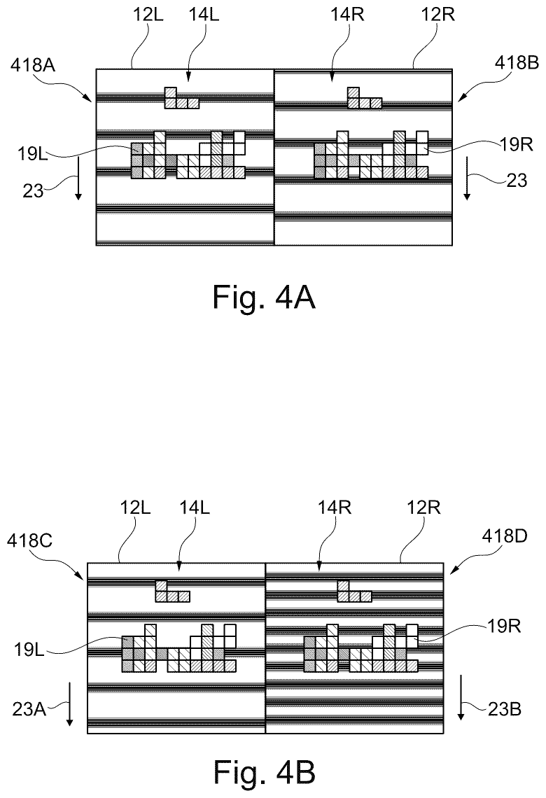

FIG. 4A shows a view of the display device 10 according to one aspect of the display system 1. The left visual content 14L comprises the grating image 418A and a visual content in the left foreground 19L. The right visual content 14R comprises the grating image 418B and a visual content in the right foreground 19R. The visual content in the left foreground 19L and the right foreground 19R is alike and represents (as an exemplary presentation of visual content) elements associated with the well-known Tetris game. The grating image 418A and the grating image 418B exhibit a spatial frequency and a drift velocity indicated by the speed vectors 23. The speed vectors 23 point in the vertical direction 9. The spatial frequency of the grating image 418A is equal to the spatial frequency of the grating image 418B. FIG. 4A further depicts a phase shift between the grating images 418A and 418B.

The state in which two grating images, for example, the grating image 418A and the grating image 418B, are simultaneously provided to the left eye 4L and the right eye 4R of the user 2 over a period of time is referred to as interocular beat. This state may also comprise the grating image 418A and the grating image 418B which differ in spatial frequency, drift velocity, and/or phase shift.

FIG. 4B shows a view of the display device 10 displaying a grating image 418C on the left display element 12L and a grating image 418D on the right display element 12R according to one aspect of the display system 1. The grating image 418C and the grating image 418D exhibit different spatial frequencies and drift velocities, as indicated by the speed vector 23A and the speed vector 23B. The visual content in the left foreground 19L and the right foreground 19R is shown as an exemplary presentation, as discussed with respect to FIG. 4A.

The grating images, as seen, for example, in FIGS. 1C, 3A, 3B, 4A, 4B, were implemented by means of the programming language WebGL, but this is not limiting of the invention. It will be understood that other programming languages, frameworks, and software tools can be used for the implementation of the grating images.

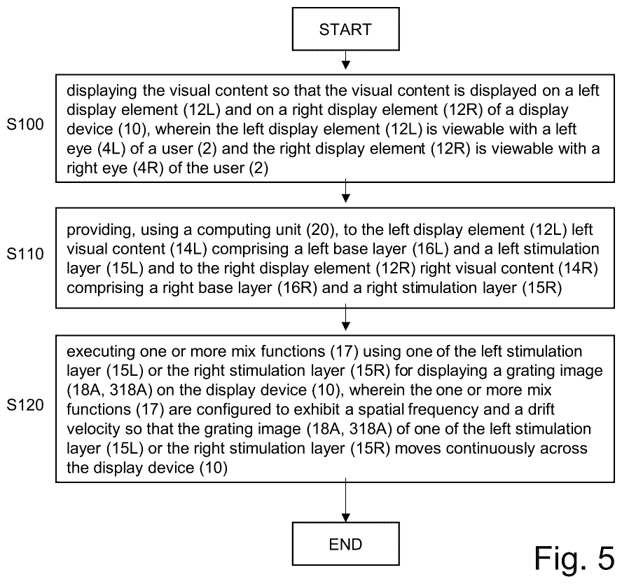

FIG. 5 shows a flow chart describing a method S for displaying the visual content to the user 2 according to one aspect. In a first step S100, the visual content is displayed on the display device 10 which comprises the left display element 12L and the right display element 12R. The display device 10 is thereby arranged so that the user 2 views the left display element 12L with the left eye 4L and the right display element 12R with the right eye 4R. In a next step S110, the left visual content 14L is provided to the left display element 12L, as well as the right visual content 14R to the right display element 14R, by means of the computer unit 20. The left visual content 14L comprises the left base layer 16L and the left stimulation layer 15L. The right visual content 14R comprises the right base layer 16R and the right stimulation layer 15R. Subsequently, in a step S120, the one or more mix functions 17 are executed using the left stimulation layer 15L or the right stimulation layer 15R so that the grating image 18A or the grating image 318A can be displayed on the display device 10. The mix functions 17 are configured to exhibit the spatial frequency and the drift velocity. The grating image 18A or the grating image 318A then moves continuously across the display device. 10.

The method S may further comprise a step to provide additional visual content for the left foreground 19L and/or the right foreground 19R. Another step may be the selection of parameters to display the grating image 18A or the grating image 318A, such as, but not limited to, the spatial frequency, the drift velocity, or the phase shift of the mix functions 17.

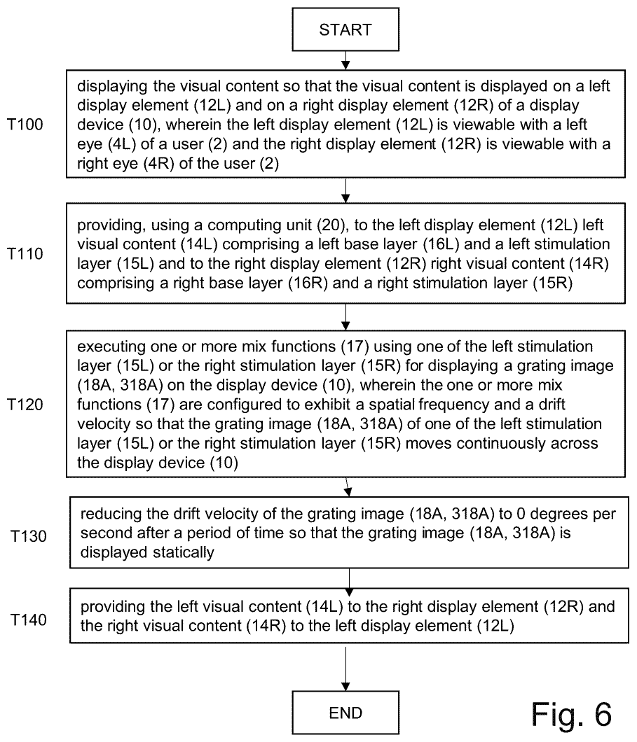

FIG. 6 shows a flow chart describing a method T for displaying the visual content according to one aspect. In a first step T100, the visual content is provided to the user 2, as discussed with respect to FIG. 5, step S100. In a second step T110, the left visual content 14L and the right visual content 14R are provided to the left display elements 12L and the right display elements 12R, as discussed with respect to FIG. 5, step S110. The mix functions 17 are then executed using the left stimulation layer 15L or the right stimulation layer 15R in step T120, as discussed with respect to FIG. 5, step S120. In a next step T130, the drift velocity of the resulting grating image 318A is reduced to 0 degrees per second. This reduction of the drift velocity can be executed very suddenly or over a predetermined period of time. The remaining (static) grating image 318A does then not move across the display device 10 and is thus displayed in a static manner. The visual content of the left display elements 12L and the right display elements 12R is finally swapped in step T140, i.e., the left visual content 14L is provided to the right display element 12R and the right visual content 14R is provided to the left display element 12L. The swap of the left visual content 14L and the right visual content 14R can be initiated immediately after the drift velocity reached 0 degrees per second. A waiting time may also be implemented after the drift velocity reached 0 degrees per second to initiate the swap.

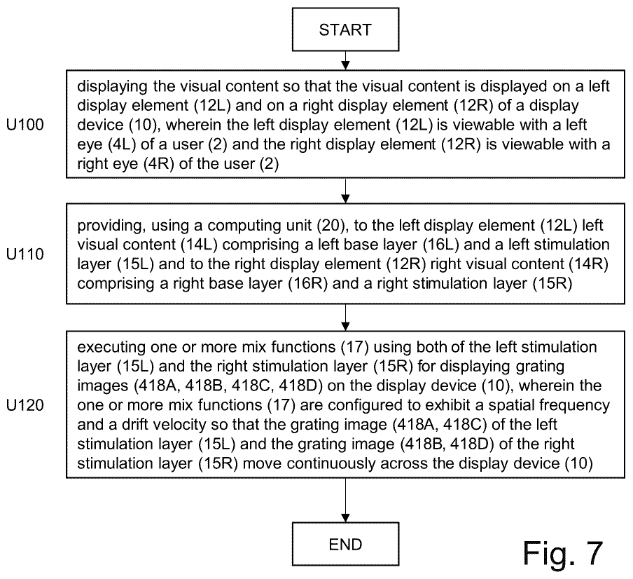

FIG. 7 shows a flow chart describing a method U for displaying the visual content according to one aspect. The method U differs from the method S, as discussed with respect to FIG. 5, in that the mix functions 17 are executed using both the left stimulation layer 15L and the right stimulation layer 15R in step U120.

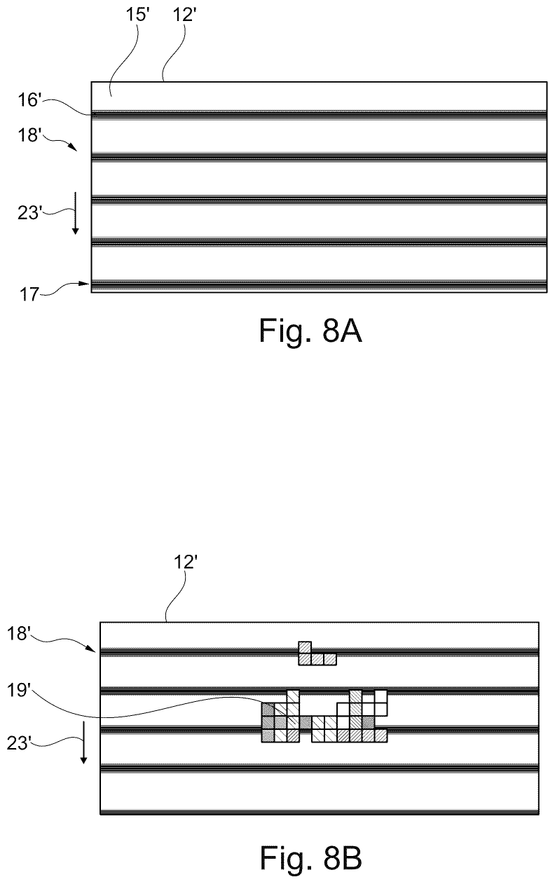

FIG. 8A shows one aspect of the invention. The fifth aspect exhibits a modification compared with the display system 1 shown in FIG. 1A. The modification comprises displaying visual content on one single display element 12′ of the display device 10. The user 2 is then able to view on the display element 12′ the displayed visual content with both the left eye 4L and the right eye 4R. The user 2 may also physically occlude one of the left eye 4L or the right eye 4R, for example, by means of a patch.

As noted above, the display element 12′ comprises, for example, but not limited to, a screen of a smartphone, tablet, monitor, or television.

The generation of the visual content comprising a grating image 18′ and a foreground 19′ is executed in an analogous manner as described with respect to FIGS. 1-7. The grating image 18′ is formed by using a base layer 16′, a stimulation layer 15′, and one or more mix functions 17. Several modifications to the grating image 18′ are applicable, such as, but not limited to, by setting a spatial frequency, drift velocity, waveform, or grating type, as discussed above.

The foreground 19′ in FIG. 8B shows the well-known Tetris game. The content of the foreground 19′ is, however, not limited to the Tetris game and may comprise any other video game. The content in the foreground 19′ may also comprise static images, interactive content, or any other kind of visual content that lengthens the period of the user's attention. It is also possible to only display the grating image 18′.

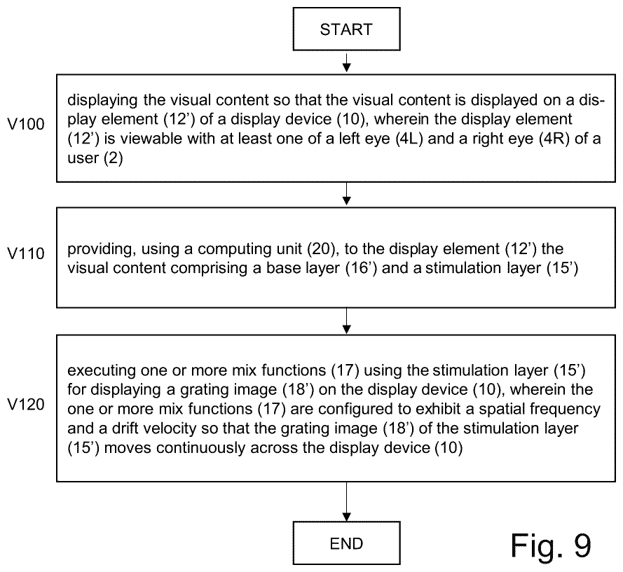

FIG. 9 shows a flow chart describing a method V for displaying the visual content according to one aspect. The method V differs from method S, as discussed with respect to FIG. 5, in that the visual content is displayed on the one single display element 12′. The visual content displayed on the display element 12′ is hence viewable with both or at least one of the left eye 4L and the right eye 4R of the user.

### Experimental Results

Some of the aspects of the present invention have been evaluated with users experiencing impairment of their vision system. The impairment of the users was related to age-related macular degeneration (AMD). A clinical study was performed to investigate the potential for improving the vision system of the users.

The clinical study comprised five users. The users performed a daily training session of 30 minutes over a period of three months. Moving grating images were presented on the one single display element for providing the visual stimuli as visual content.

The visual content provided to the users comprised grating images in the background and a game in the foreground. The grating images in the background exhibited circular grating images moving outwards from a center. The spatial frequency was set to 0.3 cyc/deg and the temporal frequency to 1 cyc/see, resulting in an angular drift velocity (drift velocity) of 3.33 deg/sec. Every week the type of grating was changed from a circular to a vertical moving grating. An increase of the spatial frequency and corresponding changes to the temporal frequency were also incorporated into the change of the visual stimuli.

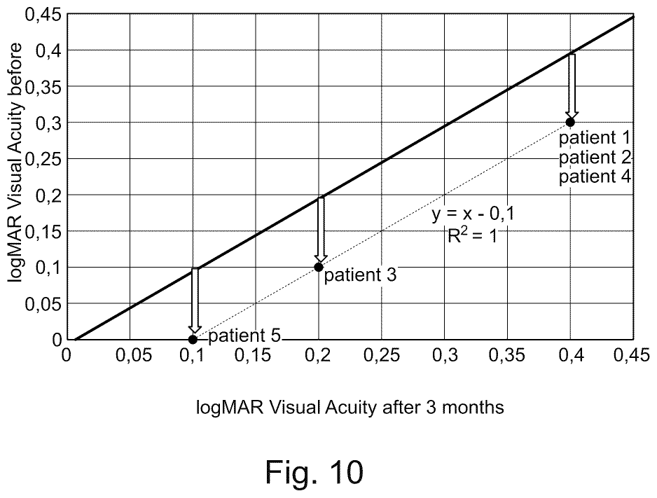

FIG. 10 shows the improvement of the vision system of the users participating in the clinical study. In FIG. 10, the average best corrected visual acuity (BCVA) in Snellen decimals (converted to the logarithm of the minimum angle of the resolution equivalents (LogMAR)) is depicted for far vision (6 m) before and after the visual training. The BCVA can be performed using, for example, but not limited to, a Snellen chart. Other procedures to determine the BCVA, as for example outlined in EN ISO 8596, may also be applicable. Before the training, the BCVA was 0.3±0.14 logMAR. The visual training over the period of 3 months improved the average far vision to 0.2±0.14. An improvement of BCVA can be seen for all the users.

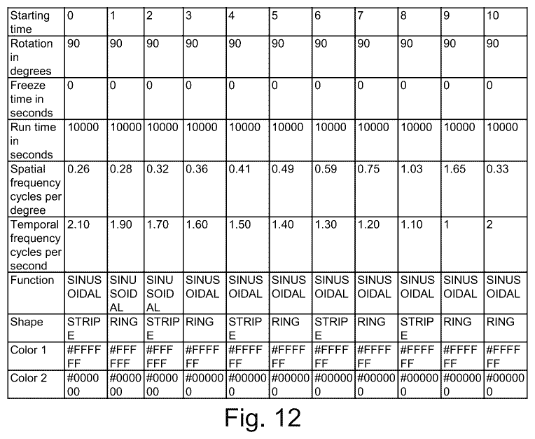

In another experimental study, the visual stimuli were changed over eleven different training sessions. The different stimuli comprised various grating images and were presented on the one single display element to the users. The parameters of the various grating images are depicted in the table of FIG. 12.

The parameters of the various grating images, as shown in the table of FIG. 12, comprise the starting time (number of the training session), rotation in degrees, freeze time in seconds, run time in seconds, spatial frequency, temporal frequency, function, shape (STRIPE equals a grating image; RING equals a circular grating image), color 1 (#FFFFFF corresponds to black), and color 2 (#000000 corresponds to white). The spatial frequency of the moving circular grating images can be implemented in two ways, i.e., whether the circular grating image moves inwards to a center or outwards from a center. The implementation, whether the circular grating image moves inwards to a center or outwards from a center, leads to a different visual perception of the moving circular grating images by the user, but does not affect the effectiveness of the provided visual stimuli. The rotation of 90 degrees corresponds to the vertical direction along which the grating image moves. The function SINUSOIDAL exhibits a sinusoidal transition from black to white with respect to the grating. In the experimental study, the colors black and white were selected to implement the grating images. It will be understood that other colors or color combinations are also possible to form a grating image, for example, but not limited to, gratings formed by the colors of blue and white, or gratings formed by the colors of red and white.

As can be seen in the table of FIG. 12, the values of the spatial frequency and the temporal frequency exhibit a reciprocal relationship. The reciprocal relationship is apparent when looking at the training sessions 0 to 9 in the table of FIG. 12. The spatial frequency was successively increased over each of the training sessions 0 to 9, while the temporal frequency was decreased. Values exhibiting the reciprocal relationship between the spatial frequency and the temporal frequency promise more effective visual stimuli for the improvement of eye conditions. Training session 10 used a different set of parameters to prepare the users for a new training cycle.

Some of the aspects of the present invention have also been evaluated with users experiencing impairment of their vision system related to amblyopia. The impairment of their vision system related to amblyopia was investigated in a further experimental study.

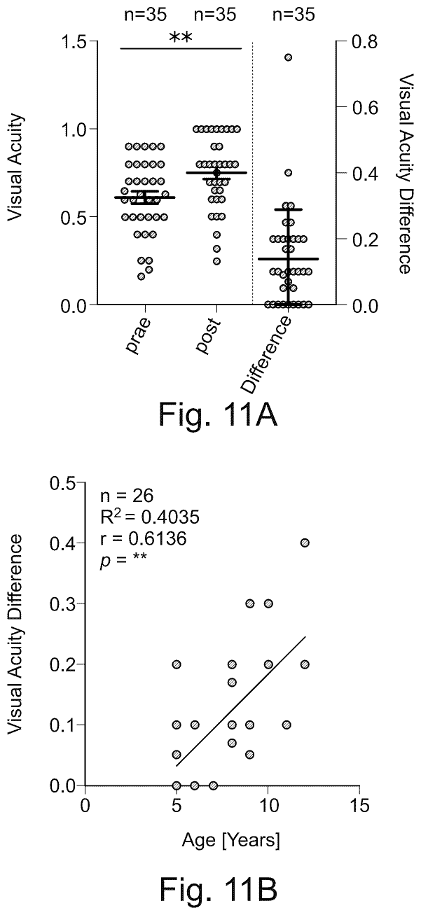

FIG. 11A and FIG. 11B shows two diagrams of the further experimental study illustrating an increase of the visual acuity of users using grating images to improve their vision system. The users were children at age four to twelve.

The further experimental study was conducted with 35 users. The 35 users had previously experienced that the improvement of their vision system did not continue by applying just classic occlusion techniques. The experimental study was performed by applying the classic occlusion techniques in combination with the additional visual stimulation of the eye suffering from amblyopia using the methods set out in this document. The additional visual stimulation comprised exposing the users to the grating images.

The results of the experimental study showed that, after three months, the combination of classic occlusion together with the additional visual stimulation improved the visual acuity of the users. The visual acuity was determined by the best corrected visual acuity (BCVA) and improved from the mean value of 0.61 with standard deviation (SD) of 0.17 to the mean value of 0.78 with standard deviation (SD) 0.18 (statistical significance: p<0.05). The study also shows that the visual stimulation is most effective for children at age seven to twelve. The increase in the visual acuity correlates with a higher age of the users (r=0.61, p<0.05).

The additional visual stimulation comprised a moving sinusoidal grating image which exhibited a particular spatial and temporal frequency. To increase the period of the user's attention, computer games were presented in the foreground.

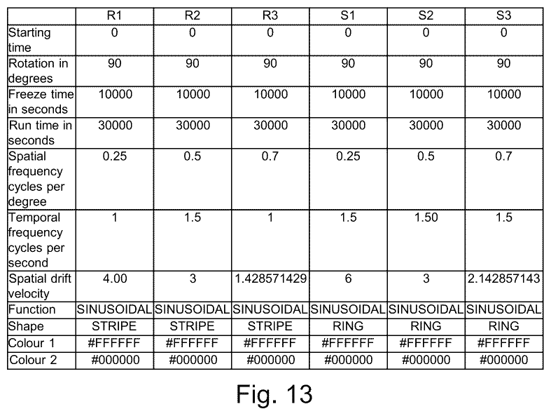

FIG. 13 shows a table comprising the parameters for setting the various grating images provided to the users. The parameters of the various grating images, as shown in the table of FIG. 13, comprise the starting time, rotation in degrees, freeze time in seconds, run time in seconds, spatial frequency, temporal frequency, function, shape (STRIPE equals a grating image; RING equals a circular grating image), color 1 (#FFFFFF corresponds to black), and color 2 (#000000 corresponds to white). The starting time is set to 0, because each of the starting times correspond to a different stimuli (depending on amblyopia with or without strabism): R1, S1: BCVA<0.4; R2, S2: BCVA 0.4-0.7; R3, S3: BCVA>0.7.

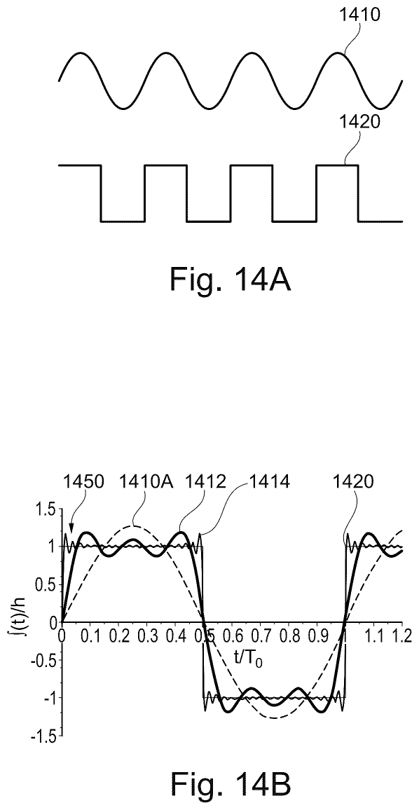

In a further aspect of the disclosure, the sinusoidal waveform of the grating images (18A, 318A, 418A, 418B, 418C, 418D) will be described in more detail. The sinusoidal waveform comprises a sinusoidal wave 1410, as depicted in FIG. 14A. The sinusoidal wave 1410 may be used to implement the sinusoidal transition, for example, from black to white with respect to gratings of the grating images (18A, 318A, 418A, 418B, 418C, 418D). The implementation of the sinusoidal transition was also discussed above with respect to the mix functions 17, but this is not limiting of the invention. It will be understood that other contrasting bi-color combinations may also be implemented.

FIG. 14A further shows a rectangular waveform 1420. The rectangular waveform 1420 has the same amplitude as the sinusoidal wave 1410. The rectangular waveform 1420 may be used to implement a (substantially) instantaneous transition from black to white with respect to gratings of the grating images (18A, 318A, 418A, 418B, 418C, 418D).

FIG. 14B illustrates one example to form a rectangular signal (i.e., the rectangular waveform 1420) by superposition of multiple ones of the sinusoidal waves. FIG. 14B shows a first sine wave 1410A (first harmonic), a second signal 1412 comprising the superposition of the first harmonic 1410A, third harmonic, and fifth harmonic, and a third signal 1414 comprising the superposition of the first twenty uneven harmonics. The third signal 1414 exhibits a rectangular-like shape which is similar to the shape of the rectangular waveform 1420. The rectangular-like shape of the third signal 1414 exhibits a signal deviation 1450 from the rectangular waveform 1420, such as under-shooting or over-shooting.

The sinusoidal wave 1410 already exhibits an elementary form of a sine wave, i.e., with a harmonic-free gradient. The sinusoidal wave 1410 does, therefore, not have the signal deviation 1450 inherent to, for example, the rectangular waveform 1420. The sinusoidal wave 1410 used in gratings of the grating images (18A, 318A, 418A, 418B, 418C, 418D) enables provision of a pure visual stimuli without any artefacts.

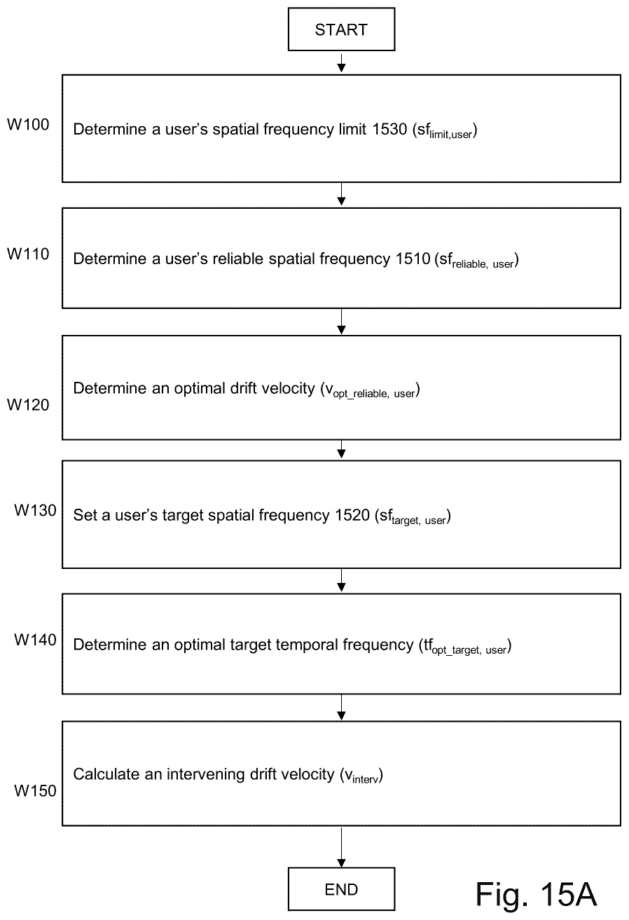

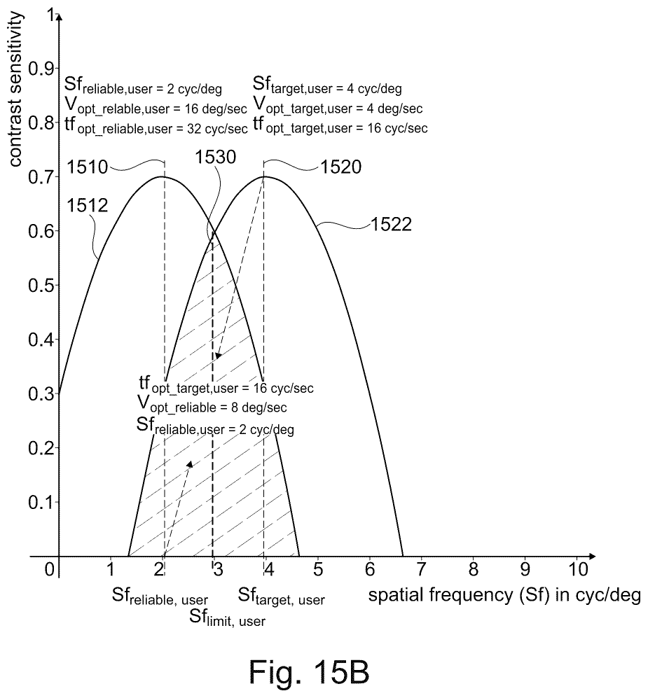

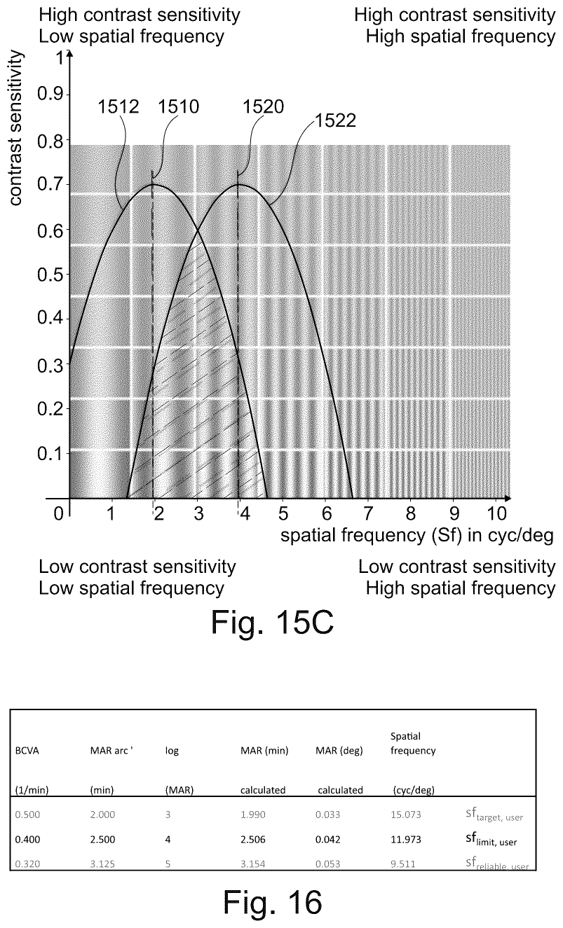

In a further aspect of the invention, a parameter selection method W is described. A flowchart of the parameter selection method W is shown in FIG. 15A. The parameter selection method W comprises the following steps: determining a user's spatial frequency limit 1530 (sf_{limit,user}) (first step W100), determining a user's reliable spatial frequency 1510 (sf_{reliable, user}) (second step W110), determining an optimal drift velocity (v_{opt_reliable, user}) (third step W120), setting a user's target spatial frequency 1520 (sf_{target, user}) (fourth step W130), determining an optimal target temporal frequency (tf_{opt_target, user}) (fifth step W140), and calculating an intervening drift velocity (vᵢₙₜₑᵣᵥ) (last step W150). The individual steps W100 to W150 of the parameter selection method W as well as the meaning of the individual parameters will be described in more detail in the following paragraphs.

The parameter selection method W comprises a user-dependent selection of the spatial frequency and the temporal frequency of gratings. The parameter selection method W enables adaption of visual stimuli to individual conditions of the user's visual system.

The parameter selection method W addresses the situation in which the user with conditions of the visual system can perceive spatial frequencies only up to a certain limit (i.e., defined as the user's spatial frequency limit 1530), whereas spatial frequencies above the certain limit can be perceived by healthy users. The user's spatial frequency limit (sf_{limit, user}) 1530 may be obtained, for example, by determining minimal angular resolution (MAR) from best corrected visual acuity (BCVA) with the unit “logMAR”, wherein logMAR can be expressed as: MAR=10logMAR (unit “minute of arc”). The BCVA can be performed using, for example, but not limited to, a Snellen test comprising a Snellen chart. It will be understood that other tests may also be used, for example a visual test comprising Landolt rings (also referred to as “Landolt C”). MAR may be converted to a corresponding spatial frequency (sf) from the equation: sf=1/(2*MAR)*60 (unit “cycles/degree”).

The parameter selection method W is further based on the theoretical background that, in the visual system, processing channels are assigned to each combination of the spatial frequency and the drift velocity. The spatial frequency (sf), the temporal frequency (tf), and the drift velocity (v) may be expressed by the following equation:

$$drift velocity ( v ) = temporal frequency ( tf ) / spatial frequency ( sf )$$

The temporal frequency (tf) may also be referred to as “stimulation frequency”. The stimulation frequency effective on an area of the user's retina may thus be obtained from the product of the drift velocity (v) and the spatial frequency (sf).

FIG. 15B illustrates one example of performing the parameter selection method W for the user. FIG. 15B shows a diagram with spatial frequencies plotted at the x-axis (unit: cyc/deg) and corresponding contrast sensitivities plotted at the y-axis ranging from zero to one.

A contrast sensitivity describes the ability of the user to differentiate between the sinusoidal transition from black to white. Zero contrast sensitivity means that the user cannot perceive any difference between the transition from black to white, whereas the value one indicates a maximum differentiation. The contrast sensitivity for different sinusoidal spatial frequencies is shown schematically in FIG. 15C.

In the first step W100 of the parameter selection method W, the user's spatial frequency limit 1530 (sf_{limit,user}) is determined, for example, by MAR from BCVA, as described above. In the one example, shown in FIG. 15B, the user's spatial frequency limit 1530 (sf_{limit,user}) is 3 cyc/deg. The second step W110 comprises determining the user's reliable spatial frequency 1510 (sf_{reliable, user}), wherein a value of the user's reliable spatial frequency 1510 (sf_{reliable, user}) is chosen so that the user can perceive a grating displaying the user's reliable spatial frequency (sf_{reliable, user}) 1510 in a reliable manner. The value of the user's reliable spatial frequency (sf_{reliable, user}) 1510 is chosen to be below the value of the user's spatial frequency limit 1530 (sf_{limit,user}).

The reliable manner may be, for example, but not limited to, an empirical determination of the user's reliable spatial frequency (sf_{reliable, user}) 1510. For example, the empirical determination may be adapted such that the user's reliable spatial frequency 1510 (sf_{reliable, user}) is chosen to be within a range of at least 20% of the the user's spatial frequency limit 1530 (sf_{limit,user}) to a maximum of 50% of the user's spatial frequency limit 1530 (sf_{limit,user}) below the user's spatial frequency limit 1530 (sf_{limit,user}).

The user's reliable spatial frequency (sf_{reliable, user}) 1510 can also be determined, for example, by means of an eye chart, such as the Snellen chart. The eye chart exhibits different lines comprising characters or signs which are to be identified by the user. The different lines are, for example, arranged such that a top line is displayed very small and a bottom line is displayed very large. The characters or symbols in the different lines between the top line and the bottom line successively increase in size towards the bottom line. It is noted that other arrangements of the eye chart are also possible, for example, that the top line is displayed very large and the bottom line is displayed very small. The difference in size of the characters or symbols between two successive ones of the different lines corresponds to a size change which is internationally standardized. The user now determines the one of the different lines of the eye chart in which the characters or symbols can still be perceived (referred to in the following as “perceivable line”), whereas the characters of symbols in an adjacent line can no longer be perceived because the symbols and the characters are too small. The perceivable line is associated with a spatial frequency which is defined as the user's spatial frequency limit 1530 (sf_{limit,user}). The user's reliable spatial frequency (sf_{reliable, user}) 1510 is subsequently determined by selecting a further perceivable line of the eye chart with larger characters or symbols which is also perceivable by the user. The further perceivable line is determined to be at least one line different from the perceivable line and is associated with the user's reliable spatial frequency (sf_{reliable, user}) 1510.

FIG. 16 shows a table comprising exemplary eye chart data for three lines of characters. The perceivable line of the user is determined to exhibit a BCVA value of 0.4 1/min corresponding to the the user's spatial frequency limit 1530 (sf_{limit,user}) of 11.973 cyc/deg. The further perceivable line in FIG. 16 is selected to be one line below the perceivable line at the eye chart corresponding to a BCVA value of 0.320 1/min and to the user's reliable spatial frequency 1510 (sf_{reliable, user}) of 9.511 cyc/deg.

In the one non-limiting example of the FIG. 15B, the value of the user's reliable spatial frequency (sf_{reliable, user}) 1510 is 2 cyc/deg. The third step W120 comprises determining the optimal drift velocity (v_{opt_reliable, user}) corresponding to the user's reliable spatial frequency (sf_{reliable, user}) 1510. In the one example, the value of optimal drift velocity (v_{opt_reliable, user}) is 16 deg/sec. The value of the optimal drift velocity (v_{opt_reliable, user}) may be, for example, obtained from the data provided in Kelly (J. Opt. Soc. Am., Vol. 69, No. 10, October 1979). Consequently, an optimal temporal frequency (tf_{opt_reliable, user}) may be calculated based on the equation mentioned above and results in 32 cyc/sec.

A first visual channel 1512 is illustrated in FIG. 15B for the optimal drift velocity (v_{opt_reliable, user}). The first visual channel 1512 describes, for ones of the different spatial frequencies, corresponding ones of the contrast sensitivities, while the value of the optimal drift velocity (v_{opt_reliable, user}) remains constant. The first visual channel 1512 exhibits a parabola-like shape, wherein the contrast sensitivity decreases for those spatial frequencies smaller or larger than the value of the user's reliable spatial frequency (sf_{reliable, user}) 1510, see FIG. 15B.

In the fourth step W130 of the parameter selection method W, the user's target spatial frequency 1520 (sf_{target, user}) is set for the user. In the one example, shown in FIG. 15B, the value of the user's target spatial frequency (sf_{target, user}) 1520 is set to 4 cyc/deg.

The user's target spatial frequency (sf_{target, user}) 1520 may be, for example, empirically determined. For example, the user's target spatial frequency (sf_{target, user}) 1520 may be chosen to be within a range of at least 20% of the the user's spatial frequency limit 1530 (sf_{limit,user}) to a maximum of 50% of the user's spatial frequency limit 1530 (sf_{limit,user}) above the user's spatial frequency limit 1530 (sf_{limit,user}).

The user's target spatial frequency (sf_{target, user}) 1520 can also be determined, for example, by means of the eye chart, as discussed above. The user's target spatial frequency (sf_{target, user}) 1520 is determined by selecting a non-perceivable line of the eye chart, i.e., a line with the characters or symbols which cannot be perceived by the user. The non-perceivable line is determined to be at least one line above the perceivable line and is associated with the user's target spatial frequency (sf_{target, user}) 1520. In FIG. 16, the non-perceivable line is selected to be one line above the perceivable line at the eye chart corresponding to a BCVA value of 0.5 1/min and to the user's target spatial frequency (sf_{target, user}) 1520 of 15.073 cyc/deg.

The fifth step W140 comprises determining the optimal target temporal frequency (tf_{opt_target, user}). A value of the optimal target temporal frequency (tf_{opt_target, user}) corresponding to the user's target spatial frequency (sf_{target, user}) 1520 may be, for example, obtained from the data provided in Kelly (J. Opt. Soc. Am., Vol. 69, No. 10, October 1979). In the one non-limiting example of the FIG. 15B, the value of the optimal target temporal frequency (tf_{opt_target, user}) is set to 16 cyc/see resulting in an optimal target drift velocity (v_{opt_target, user}) of 4 deg/sec.

A second visual channel 1522 is illustrated in FIG. 15B for the v_{opt_target, user}. The second visual channel 1522 describes for different spatial frequencies corresponding contrast sensitivities, wherein the value of v_{opt_target, user} is kept constant. The second visual channel 1522 exhibits a parabola-like shape, wherein the contrast sensitivity decreases for spatial frequencies smaller or larger than the user's target spatial frequency (sf_{target, user}) 1520.

The sixth step W150 finally comprises calculating the intervening drift velocity (vᵢₙₜₑᵣᵥ), wherein a value of the intervening drift velocity (vᵢₙₜₑᵣᵥ) is calculated by the following formular expression:

$$intervening drift velocity ( {v}_{interv} ) = optimal target temporal frequency ( {tf}_{opt \_ target , user} ) / user ' s reliable spatial frequency ( {sf}_{reliable , user} )$$

The obtained value of the intervening drift velocity (vᵢₙₜₑᵣᵥ) is thus 8 deg/sec for the one example.

The parameter selection method W enables the determination of user-dependent visual stimuli in the form of adapted moving sinusoidal grating images. The adapted moving sinusoidal grating images are chosen to correspond to the first visual channel 1512 by the user's reliable spatial frequency (sf_{reliable, user}) 1510 but also to the intervening drift velocity (vᵢₙₜₑᵣᵥ). The intervening drift velocity (vᵢₙₜₑᵣᵥ) is, however, reduced compared to the optimal drift velocity (v_{opt_reliable, user}) since the intervening drift velocity (vᵢₙₜₑᵣᵥ) is also based on the optimal target temporal frequency (tf_{opt_target, user}). The adapted reduction of the drift velocity of the adapted moving sinusoidal grating images may also be referred to as a “drift velocity downshift”.

The parameter selection method W enables the described drift velocity downshift in order to stimulate the visual channels which can no longer be perceived by the user. In other words, the parameter selection method W uses two overlapping visual channels such that stimulation of the one visual channel may be associated with stimulation (reactivation) of the other visual channel by crosstalk in an indirect manner resulting in an enhanced visual stimuli to improve the vision system of the user. The dashed area in FIG. 15B illustrates the overlapping of the two overlapping visual channels, for instance, the second visual channel 1522 can cause the stimulation (reactivation) of the first visual channel 1512 using the temporal frequency of the second visual channel 1522 by the crosstalk in the indirect manner.

The present invention discloses the display system 1 and the methods S, T, U, V, and W as described above, for improving amblyopia and dry age-related macular degeneration (AMD) but may also be used for improving other neurodevelopmental and/or neurodegenerative conditions of the visual system, as for example, but not limited to, glaucoma or progressive myopia.

According to a first aspect, a display system for displaying visual content comprises a display device for displaying the visual content configured to provide a left display element and a right display element, a computer unit for providing the visual content to the display device, wherein the computer unit is configured to provide to the left display element left visual content comprising a left base layer and a left stimulation layer and to the right display element right visual content comprising a right base layer and a right stimulation layer, wherein at least one of the left stimulation layer and the right stimulation layer is implemented with one or more mix functions to display a grating image on the display device, and wherein the one or more mix functions are configured to exhibit a spatial frequency and a drift velocity so that the grating image of the at least one of the left stimulation layer and the right stimulation layer moves continuously across the display device.

According to a second aspect, a display system for displaying visual content comprises a display device for displaying the visual content configured to provide a display element, a computer unit for providing the visual content to the display device, wherein the computer unit is configured to provide to the display element the visual content comprising a base layer and a stimulation layer, wherein the stimulation layer is implemented with one or more mix functions to display a grating image on the display device, and wherein the one or more mix functions are configured to exhibit a spatial frequency and a drift velocity so that the grating image of the stimulation layer moves continuously across the display device.

According to a third aspect, The display system according to the first or the second aspect, wherein the spatial frequency and the drift velocity are obtained by a method according to aspect 30.

According to a fourth aspect, the display system according to one of the aspects 1 to 3, the one or more mix functions are configured to exhibit the spatial frequency in the range of 0 to 60 cycles per degree.

According to a fifth aspect, the display system according to one of the aspects 1 to 4, wherein the one or more mix functions are configured to exhibit the drift velocity in the range of 0 to 32 degrees per second.

According to a sixth aspect, the display system according to one of the aspects 1 to 5, wherein the one or more mix functions are configured to exhibit a temporal frequency in the range of 0 to 32 cycles per second.

According to a seventh aspect, the display system according to one of the aspects 1 to 6, wherein the one or more mix functions are configured to exhibit a waveform in the form of a sinusoidal wave.

According to an eighth aspect, the display system according to one of the aspects 1 to 7, wherein the spatial frequency comprises a first spatial frequency for a first period of time and a second spatial frequency for a second period of time.

According to a ninth aspect, the display system according to one of the aspects 1 to 8, wherein the drift velocity comprises a first drift velocity for a first period of time and a second drift velocity for a second period of time.

According to a tenth aspect, the display system according to one of the aspects 1 to 9, wherein the one or more mix functions are configured to generate a circular grating type in the form of concentric circles.

According to a eleventh aspect, the display system according to one of the aspects 1 to 10, wherein the drift velocity of the grating image is reduced to 0 degrees per second after a period of time so that the grating image is displayed statically.

According to a twelfth aspect, the display system according to the eleventh aspect, wherein the left visual content is provided to the right display element and the right visual content is provided to the left display element.

According to a thirteenth aspect, the display system according to one of the aspects 1, 3 to 10, wherein a phase shift between the one or more mix functions of the left stimulation layer and the one or more mix functions of the right stimulation layer is in the range of 0 to 179 degree.

According to a fourteenth aspect, the display system according to one of the aspects 1, 3 to 10 or 13, wherein the drift velocity of the one or more mix functions of the left stimulation layer and the drift velocity of the one or more mix functions of the right stimulation layer are different.

According to a fifteenth aspect, the display system according to one of the aspects 1, 3 to 10 or 13 to 14, wherein the spatial frequency of the one or more mix functions of the left stimulation layer and the spatial frequency of the one or more mix functions of the right stimulation layer are different.

According to a sixteenth aspect, the display system according to aspect 13 or 15, wherein the visual content in the left foreground of the left visual content and the visual content in the right foreground of the right visual content are alike.

According to a seventeenth aspect, the display system according to one of the aspects 1 to 16, wherein a feedback device is provided so that a user can provide feedback to the computer unit.

According to an eighteenth aspect, the display system according to one of the aspects 1 to 17, wherein an input device is provided so that at least one of the spatial frequencies, the drift velocities, the waveform, the phase shift, the grating type, and a grating orientation of the one or more mix functions is set according to a user configurable setting.

According to an nineteenth aspect, a method for displaying visual content comprises the following steps: displaying the visual content so that the visual content is displayed on a left display element and on a right display element of a display device, wherein the left display element is viewable with a left eye of a user and the right display element is viewable with a right eye of the user; providing, using a computing unit, to the left display element left visual content comprising a left base layer and a left stimulation layer and to the right display element right visual content comprising a right base layer and a right stimulation layer; and executing one or more mix functions using one of the left stimulation layer or the right stimulation layer for displaying a grating image on the display device, wherein the one or more mix functions are configured to exhibit a spatial frequency and a drift velocity so that the grating image of one of the left stimulation layer or the right stimulation layer moves continuously across the display device.

According to an twentieth aspect, the method according to aspect 19, further comprising selecting values with respect to the spatial frequency, the drift velocity, a waveform, a phase shift, a grating type, and a grating orientation of the one or more mix functions for displaying a user configurable grating image using an input device.

According to a twenty-first aspect, a method for displaying visual content comprises the following steps: displaying the visual content so that the visual content is displayed on a left display element and on a right display element of a display device, wherein the left display element is viewable with a left eye of a user and the right display element is viewable with a right eye of the user; providing, using a computing unit, to the left display element left visual content comprising a left base layer and a left stimulation layer and to the right display element right visual content comprising a right base layer and a right stimulation layer; executing one or more mix functions using one of the left stimulation layer or the right stimulation layer for displaying a grating image on the display device, wherein the one or more mix functions are configured to exhibit a spatial frequency and a drift velocity so that the grating image of one of the left stimulation layer or the right stimulation layer moves continuously across the display device; reducing the drift velocity of the grating image to 0 degrees per second after a period of time so that the grating image is displayed statically; and providing the left visual content to the right display element and the right visual content to the left display element.

According to a twenty-second aspect, the method according to aspect 21, further comprising receiving feedback from the user using a feedback device.

According to a twenty-third aspect, the method according to aspect 21 or 22, further comprising selecting values with respect to the spatial frequency, the drift velocity, a waveform, a phase shift, a grating type, and a grating orientation of the one or more mix functions for displaying a user configurable grating image using an input device.

According to a twenty-fourth aspect, a method for displaying visual content comprising the following steps: displaying the visual content so that the visual content is displayed on a left display element and on a right display element of a display device, wherein the left display element is viewable with a left eye of a user and the right display element is viewable with a right eye of the user; providing, using a computing unit, to the left display element left visual content comprising a left base layer and a left stimulation layer and to the right display element right visual content comprising a right base layer and a right stimulation layer; and executing one or more mix functions using both of the left stimulation layer and the right stimulation layer for displaying grating images on the display device, wherein the one or more mix functions are configured to exhibit a spatial frequency and a drift velocity so that the grating image of the left stimulation layer and the grating image of the right stimulation layer move continuously across the display device.

According to a twenty-fifth aspect, the method according to aspect 24, further comprising selecting values with respect to the spatial frequency, the drift velocity, a waveform, a phase shift, a grating type, and a grating orientation of the one or more mix functions for displaying user configurable grating images using an input device.

According to a twenty-sixth aspect, the display system according to one of the aspects 2 to 11, wherein the visual content in a foreground comprises at least one of video games or interactive content.

According to a twenty-seventh aspect, a method for displaying visual content comprising the following steps: displaying the visual content so that the visual content is displayed on a display element of a display device, wherein the display element is viewable with at least one of a left eye and a right eye of a user; providing, using a computing unit, to the display element the visual content comprising a base layer and a stimulation layer; and executing one or more mix functions using the stimulation layer for displaying a grating image on the display device, wherein the one or more mix functions are configured to exhibit a spatial frequency and a drift velocity so that the grating image of the stimulation layer moves continuously across the display device.

According to a twenty-eightth aspect, the method according to aspect 27, further comprising selecting values with respect to the spatial frequency, the drift velocity, a waveform, a grating type, and a grating orientation of the one or more mix functions for displaying a user configurable grating image using an input device.

According to a twenty-ninth aspect, a use of visual content for the improvement of conditions of the visual system comprising using a display system for a user with eye conditions; determining parameters of the display system with respect to a left eye and a right eye of the user; setting the parameters of the display system according to the eye conditions of the user; and providing the visual content to the user.

According to a thirtieth aspect, a method for generating a user-dependent moving grating image comprising the following steps: determining a user's spatial frequency limit; determining a user's reliable spatial frequency; setting a user's target spatial frequency 1520; determining an optimal target temporal frequency; and calculating an intervening drift velocity.

According to a thirty-first aspect, the method according to aspect 30, further comprising determining an optimal drift velocity.

### REFERENCE NUMERALS

1 Display system
2 User
3 Head-mounted apparatus
4L Left eye of a user
4R Right eye of a user
6 Feedback device
7 Input device
8 Horizontal direction of the display element
9 Vertical direction of the display element
10 Display device
12L Left display element
12R Right display element
12′ Display element
14L Left visual content
14R Right visual content
15L Left stimulation layer
15R Right stimulation layer
15′ Stimulation layer
16L Left base layer
16R Right base layer
16′ Base layer
17 Mix function
18A, 318A, 418A, Grating image
418B, 418C, 418D,
18′
19L Left foreground
19R Right foreground
19′ Foreground
20 Computer unit
21 First direction of implementation
22 Second direction of implementation
23, 23A, 23B, 23′ Speed vector
24 Origin of the coordinate system
25 Diagram of the mix function
1410, 1410A Sinusoidal wave (first harmonic)
1412 Second signal
1414 Third signal
1420 Rectangular waveform
1450 Signal deviation
1510 User's reliable spatial frequency (sf_{reliable, user})
1512 First visual channel
1520 User's Target spatial frequency (sf_{target, user})
1522 Second visual channel
1530 User's spatial frequency limit (sf_{limit,user})
S Method 1
T Method 2
U Method 3
V Method 4
W Method 5

1. A display system for displaying visual content comprising:
a display device for displaying the visual content configured to provide a left display element and a right display element;
a computer unit for providing the visual content to the display device, wherein the computer unit is configured to provide to the left display element left visual content comprising a left base layer and a left stimulation layer and to the right display element right visual content comprising a right base layer and a right stimulation layer, wherein
at least one of the left stimulation layer and the right stimulation layer is implemented with one or more mix functions to display a grating image on the display device, and wherein
the one or more mix functions are configured to exhibit a spatial frequency and a drift velocity so that the grating image of the at least one of the left stimulation layer and the right stimulation layer moves continuously across the display device.

2. (canceled)

3. The display system according to claim 1, wherein the spatial frequency and the drift velocity are obtained by a method according to claim 30.

4. The display system according to claim 1, wherein the one or more mix functions are configured to exhibit the spatial frequency in the range of 0 to 60 cycles per degree.

5. The display system according to claim 1, wherein the one or more mix functions are configured to exhibit the drift velocity in the range of 0 to 32 degrees per second.

6. The display system according to claim 1, wherein the one or more mix functions are configured to exhibit a temporal frequency in the range of 0 to 32 cycles per second.

7. The display system according to claim 1, wherein the one or more mix functions are configured to exhibit a waveform in the form of a sinusoidal wave.

8. The display system according to claim 1, wherein the spatial frequency comprises a first spatial frequency for a first period of time and a second spatial frequency for a second period of time.

9. The display system according to claim 1, wherein the drift velocity comprises a first drift velocity for a first period of time and a second drift velocity for a second period of time.

10. The display system according to claim 1, wherein the one or more mix functions are configured to generate a circular grating type in the form of concentric circles.

11. The display system according to claim 1, wherein the drift velocity of the grating image is reduced to 0 degrees per second after a period of time so that the grating image is displayed statically.

12. The display system according to claim 9, wherein the left visual content is provided to the right display element and the right visual content is provided to the left display element.

13. The display system according to claim 1, wherein a phase shift between the one or more mix functions of the left stimulation layer and the one or more mix functions of the right stimulation layer is in the range of 0 to 179 degree.

14. The display system according to claim 1, wherein the drift velocity of the one or more mix functions of the left stimulation layer and the drift velocity of the one or more mix functions of the right stimulation layer are different.

15. The display system according to claim 1, wherein the spatial frequency of the one or more mix functions of the left stimulation layer and the spatial frequency of the one or more mix functions of the right stimulation layer are different.

16. The display system according to claim 11, wherein the visual content in the left foreground of the left visual content and the visual content in the right foreground of the right visual content are alike.

17. The display system according to claim 1, wherein a feedback device is provided so that a user can provide feedback to the computer unit.

18. The display system according to claim 1, wherein an input device is provided so that at least one of the spatial frequencies, the drift velocities, the waveform, the phase shift, the grating type, and a grating orientation of the one or more mix functions is set according to a user configurable setting.

19. A method for displaying visual content comprising the following steps:
displaying the visual content so that the visual content is displayed on a left display element and on a right display element of a display device, wherein the left display element is viewable with a left eye of a user and the right display element is viewable with a right eye of the user;
providing, using a computing unit, to the left display element left visual content comprising a left base layer and a left stimulation layer and to the right display element right visual content comprising a right base layer and a right stimulation layer; and
executing one or more mix functions using one of the left stimulation layer or the right stimulation layer for displaying a grating image on the display device, wherein the one or more mix functions are configured to exhibit a spatial frequency and a drift velocity so that the grating image of one of the left stimulation layer or the right stimulation layer moves continuously across the display device.

20. The method according to claim 17, further comprising selecting values with respect to the spatial frequency, the drift velocity, a waveform, a phase shift, a grating type, and a grating orientation of the one or more mix functions for displaying a user configurable grating image using an input device.

21. (canceled)

22. (canceled)

23. (canceled)

24. (canceled)

25. (canceled)

26. (canceled)

27. (canceled)

28. (canceled)

29. (canceled)

30. (canceled)

31. (canceled)
